(19) United States
(12) Patent Application Publication
(10) Pub. No.: US 2007/0245261 A1
(43) Pub. Date: Oct. 18, 2007

(54) Task oriented navigation

(75) Inventors: Mai-lan Tomsen Bukovec, Seattle, WA (US); Eric B. Watson, Redmond, WA (US); Michael H. LaManna, Bothell, WA (US); Erin M. Bourke-Dunphy, Seattle, WA (US); James D. Harriger, Duvall, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/376,874

(22) Filed: Mar. 15, 2006

(51) Int. Cl. G06F 9/44

(52) U.S. Cl. 715/810; 705/7; 705/8

(57) ABSTRACT

Multiple options, techniques, and procedures can be provided for navigating, accessing, and displaying tasks, task templates, or instances of task templates. Two options can be presented for navigating to a task template using a user interface. One option can comprise selecting a task from a contextual task list, and the other option can comprise selecting a context-free task. A user can visually switch between two procedures for providing access to a task template. A first procedure can comprise invoking the task template by selecting a task from a context-free task list. A second procedure can comprise invoking the task template by selecting a contextual task from a contextual task list that displayed as a result of a selection of an entity from a topology view. Other techniques for task navigation can comprise displaying a topology view and a contextual task list, and displaying a list of context-free tasks.

### BACKGROUND

Despite advances in technology, performing tasks for managing a collection of computers and software can be difficult. For example, managing a computer environment can involve working with many different software applications. Each application can have many different user interfaces for operating the application. A user operating such a computer environment may not have the knowledge or expertise to manage the environment correctly or efficiently. For example, a user who encounters a problem may not know which user interface in which application to access in order to resolve the problem. A user may also not know which application, or which user interface within the application, to use in order to accomplish a task.

A user managing a computer environment may have to use object-oriented navigation in order to accomplish a task, make changes, or resolve a problem. Object-oriented navigation can involve navigating a hierarchy of objects in order to reach the desired user interface to accomplish the task, make the change, or resolve the problem. However, the user may not know which objects to navigate in order to reach the desired user interface.

Therefore, there exists ample room for improvement in technologies related to performing tasks for managing a computer environment.

### SUMMARY

A variety of technologies related to task oriented navigation can be applied. Such technologies can be used for navigating to a task template using a user interface and presenting a user with two options for navigation. A first option for navigating to the task template (e.g., a first instance of the task template) can be presented by displaying a contextual list of tasks, receiving a selection by the user of one of the tasks, and displaying the task template (e.g., a first instance of the task template) associated with the selected task from the list of contextual tasks. A second option for navigating to the task template (e.g., a second instance of the task template) can be presented by displaying a context-free task (e.g., as part of a context-free task list), receiving a selection of the task from the user, and displaying the task template (e.g., a second instance of the task template) associated with the selected context-free task.

A contextual list of tasks can be displayed based on a variety of events. For example, a contextual list of tasks can be displayed based on a selection of an entity or entity group. It can also be displayed based on a selection of an object, asset or a solution. Entities, entity groups, and assets can be displayed, in a user interface, as a list view or as a topology view (e.g., a graphical topology view).

Such technologies can also be used to visually switch between two procedures for providing access to a task template (e.g., to an instance of the task template). For example, a context-free task list can be displayed, and a selection received from the list in order to access the task template. A contextual task list can also be displayed (e.g., based on a selection of an entity from a topology view), and a selection received from the list in order to access the task template.

Such technologies can also be used to support two techniques for task navigation using a user interface. For example, a first technique can comprise displaying a topology view, receiving a selection of an entity from the topology view, displaying a list of contextual tasks, receiving a selection of one of the tasks, and displaying a task template associated with the selected contextual task. A second technique can comprise displaying a list of context-free tasks, receiving a selection from the list, and displaying a task template associated with the selected context-free task. The displayed task template can be the same task template regardless of which technique is used.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram showing an exemplary system for accessing tasks.

FIG. 2 is a flowchart showing an exemplary method for navigating to a task template by presenting a first and second option.

FIG. 3 is a diagram showing an exemplary user interface depicting entity groups.

FIG. 4 is a diagram showing an exemplary user interface depicting a context-free task list.

FIG. 5 is a diagram showing an exemplary user interface depicting a contextual task list.

FIG. 6 is a diagram showing an exemplary user interface depicting a context-free task list and a contextual task list.

FIG. 7 is a diagram showing an exemplary user interface depicting a contextual task list associated with an entity.

FIG. 8 is a diagram showing an exemplary user interface depicting a specific context-free task list.

FIG. 9 is a diagram showing an exemplary user interface depicting a specific contextual task list.

FIG. 10 is a diagram showing an exemplary user interface depicting a topology view.

FIG. 11 is a diagram showing an exemplary user interface depicting assets.

FIG. 12 is a diagram showing an exemplary user interface depicting solutions.

FIG. 13 is a flowchart showing an exemplary method for navigating to a task template using a user interface.

FIG. 14 is a flowchart showing an exemplary method for visually switching between two procedures for providing access to a task template.

FIG. 15 is a flowchart showing an exemplary method supporting two techniques for task navigation.

FIG. 16 is a flowchart showing an exemplary method for completing a task.

FIG. 17 is a diagram showing an exemplary multi-server system for performing tasks.

FIG. 18 is a diagram showing an exemplary user interface depicting an add user task.

FIG. 19 is a diagram showing an exemplary user interface for adding a user.

FIG. 20 is a diagram showing an exemplary user interface depicting a selected users entity group.

FIG. 21 is a diagram showing an exemplary user interface depicting a selected user entity.

FIG. 22 is a block diagram illustrating an example of a computing environment that can be used to implement any of the technologies described herein.

FIG. 23 is block diagram illustrating an example of a computer system that can be used to implement any of the technologies described herein.

### DETAILED DESCRIPTION OF EXEMPLARY EMBODIMENTS

### Example 1

### Exemplary Task

In any of the examples herein, a task can represent work that is performed on a computer network (e.g., a multi-server computer environment of a business or organization). For example, a task can represent the retrieval of information that is displayed to a user of the network (e.g., for troubleshooting purposes). A task can also represent making a change to the network (e.g., changing settings in an application). A task can be performed, for example, by using a task template. For display purposes, a user interface element (e.g., a button or link) can be displayed for initiating a task.

Selecting (e.g., invoking) a task can result in displaying a user interface for accomplishing (e.g., completing) the task. For example, selecting a task (e.g., by selecting a user interface element associated with the task) can result in displaying a custom user interface that allows a user to make changes to a number of applications and computer servers on a network. For example, selecting a “manage licenses” task (e.g., selecting a button or link associated with the text “manage licenses”) can result in display of a custom user interface that allows a user of a network to manage licenses for users and devices across multiple servers and services. Selecting a task can also result in display of a user interface that is part of an application on a network (e.g., a user interface that is already native to an application). For example, selecting a “change password” task for a selected user can result in display of a “change password” user interface from a user management application.

Selecting a task can result in display of various types of user interfaces. For example, a wizard user interface can be displayed (e.g., where the user is directed through a series of step). A dialog can be displayed (e.g., the user can be asked to confirm the deletion of a user account). A view can also be displayed (e.g., a page allowing the user to configure various settings, such as web site settings).

### Example 2

### Exemplary Task Template

In any of the examples herein, a task template can be used to accomplish (e.g., complete) a task. For example, a task template can be used to direct a user to a user interface for accomplishing a task. For example, a task template can comprise a location variable. The location variable can contain a location. The location can represent (e.g., be an address of) a user interface (e.g., a wizard, dialog, or view). For example, the location can represent a user interface by way of an API of an application. A task template can be in the format of a schema (e.g., an XML schema).

A task template can also be stored in a variety of ways and in a variety of locations. For example, task templates can be stored as data values in a database of task templates (e.g., on a computer server). Task templates can also be stored as schemas (e.g., in a flat file), using an XML schema.

A task template can be used when a task is selected (e.g., invoked). For example, a task to add a new user to a network can be selected. In response, a location variable from a task template related to the task can be used to display a user interface identified by the location variable.

Selecting (e.g., invoking) or displaying a task template can comprise selecting or displaying an instance of the task template (e.g., displaying a user interface for accomplishing a task). An instance of a task template can be a specific occurrence of the task template. For example, a first instance of a task template can be displayed when a task template is selected (e.g., from a context-free task), and based on a location variable from the task template, a user interface of an application is displayed. A second instance of the same task template can also be displayed when the task template is selected (e.g., from a contextual task). In this way, multiple instances of the same task template can be selected and displayed.

The same task can be selected multiple times and multiple instances of the same task template displayed (e.g., at different times or at the same time). For example, an add user task can be selected multiple times and multiple instances of an add user task template can be displayed (e.g., multiple windows in a user interface, each window comprising fields for adding a user, such as: user name, real name, and password).

Or, different tasks can be selected and multiple instances of the same task template displayed. For example, an edit user task for a specific user can be selected and an instance of an edit user template can be displayed (e.g., filled in with the specific user's information). An edit user task for a different specific user can also be selected and an instance of the same edit user template can be displayed (e.g., filled in with the different specific user's information).

### Example 3

### Exemplary Entity

In any of the examples herein, an entity can be an object (e.g., an object associated with a computer network). For example, an entity can be a computer (e.g., a desktop, laptop, server), a user, a printer, a network device (e.g., switch, hub, router), a configuration setting, a license, or any other type of entity. Entities can be grouped together in entity groups.

Tasks can be performed on an entity. For example, an entity can be selected (e.g., by a user in a user interface). Selecting an entity (e.g., clicking or right-clicking on an icon representing the entity in a user interface) can display a list of tasks (e.g., a list of user interface elements for initiating the tasks). The list of tasks can be associated with the entity. A task from the list of tasks can be selected and, using an associated task template, a user interface can be displayed for completing the task.

### Example 4

### Exemplary Entity Group

In any of the examples herein, an entity group can comprise a collection of entities. The collection of entities can be homogeneous or heterogeneous. For example, a homogeneous users entity group can comprise a collection of user entities. A heterogeneous email entity group can comprise a collection of entities that participate in email activities, such as: users, email servers, client email applications, and server email applications.

The collection of entities can be related. For example, a network entity group can comprise a collection of entities related to the network (e.g., servers, user computers, printers).

Tasks can be performed on an entity group. For example, an entity group can be selected (e.g., by a user in a user interface). Selecting an entity group (e.g., clicking on an icon representing the entity group) can display a list of tasks (e.g., a list of user interface elements for initiating the tasks). The list of tasks can be associated with the entity group. A task from the list of tasks can be selected and, using an associated task template, a user interface can be displayed for completing the task. For example, selecting a network entity group can display a task for viewing bandwidth usage across the network (e.g., across the entities comprising the network entity group).

### Example 5

### Exemplary Contextual Task

In any of the examples herein, a task can be a contextual task. A contextual task can be a task that is associated with a selected entity or entity group (e.g., the task applies to or will be performed on the selected entity or entity group). For example, if a user is presented with a user interface displaying a number of entity groups, the user can select one of the entity groups. Once the user has selected one of the entity groups, a list of contextual tasks can be displayed (e.g., a list of user interface elements for initiating the contextual tasks). The list of tasks is contextual because it is associated (e.g., scoped) with the selected entity group. For example, if the user selects a network entity group, the list of contextual tasks would be associated to the network entity group. An example of contextual tasks associated with a network entity group can be: view performance, view alerts, and view events.

Similarly, for example, if a user is presented with a user interface displaying a number of entities, the user can select one of the entities. Once the user has selected one of the entities, a list of contextual tasks can be displayed. The list of tasks is contextual because it is associated (e.g., scoped) with the selected entity (e.g., the tasks apply to or will be performed on the selected entity). For example, if the user selects a specific computer server from a computer servers entity group, the list of contextual tasks would be associated with the specific computer server. An example of contextual tasks associated with a specific computer server entity can be: approve updates, configure web server, deploy new software package, view performance, view alerts, and view events. For example, the approve updates contextual task can allow a user to approve updates for the selected computer server entity.

A contextual task can also be a task associated with an asset or a solution (or a group of assets or solutions).

### Example 6

### Exemplary Context-Free Task

In any of the examples herein, a task can be a context-free task. A context-free task can be a task that is displayed (e.g., as a user interface element for initiating the context-free task) regardless of whether an entity or entity group is selected (e.g., a context-free task is not tied to the display of an entity or an entity group). A context-free task can also be a task that is displayed (e.g., as a user interface element for initiating the context-free task) regardless of whether an asset or solution (or a group of assets or solutions) is selected. Therefore, context-free tasks can be displayed independently of contextual tasks. A context-free task can also be known as a global task.

For example, a user can be presented with a user interface in which there are no entities or entity groups selected. A list of context-free tasks can be displayed in the user interface. For example, the list of context-free tasks can include: approve updates on server 1, review email license usage, and view file server performance.

Context-free tasks can also be displayed at the same time (e.g., simultaneously, concurrently, contemporaneously) as contextual tasks. For example, a list of context-free tasks can be displayed in a user interface (where there are no entities or entity groups selected). A user can then select an entity or entity group which causes display (e.g., in a separate area of the user interface) of a list of contextual tasks. The list of context-free tasks can have a label identifying the list, as can the list of contextual tasks. The context-free tasks and contextual tasks can also be mixed (e.g., in a single list of tasks).

Displaying a list of contextual tasks can cause a list of context-free tasks to be removed (e.g., from being displayed in a user interface). For example, if a user selects an entity or entity group, then a currently displayed list of context-free tasks can be removed and a list of contextual tasks displayed instead (e.g., replaced by the list of contextual tasks in the same area of the user interface, or in a different area of the user interface).

### Example 7

### Exemplary Asset

In any of the examples herein, an asset can be a physical asset. For example, an asset can be a computer, a printer, or a network device. An asset can also be a non-physical asset such as a user account or a license. An asset can also be an entity. Tasks can be performed on assets (e.g., by selecting an asset and selecting from a list of displayed tasks, such as a contextual list of tasks related to a selected asset).

A user can pivot between display of an asset view and a solution view. For example, a user can select an entity group. Then, the user can pivot between an asset view and a solution view of the selected entity group. An asset view of a selected entity group can comprise a number of homogeneous entities.

### Example 8

### Exemplary Solution

In any of the examples herein, a solution can be a logical grouping of entities, assets, or both. A solution can be a collection of entities or assets based on an abstract relationship between the entities or assets. A solution can be a collection of heterogeneous entities or assets. Examples of solutions can be: networking, printing, email, accounting, file storage, and internet sites. For example, an email solution can comprise entities and entity groups related to email activities, such as: users, servers (e.g., email servers), and user email applications.

Tasks can be performed on solutions. For example, an email solution can be selected. Based on the selection, a list of tasks (e.g., contextual tasks) can be displayed. One of the contextual tasks can be, for example, configuring spam-filtering settings.

A solution can be pre-created or manually created. For example, a management application can come with a pre-created set of solutions (e.g., an email solution comprising users and servers that participate in email services). A user can also manually create a solution by manually associating computers, servers, users or other entities. For example, a user can create a solution representing an accounting department of a business (e.g., users, computers, services, and applications involved with accounting activities).

A user can pivot between display of an asset view and a solution view. For example, a user can select an entity group. Then, the user can pivot between an asset view and a solution view of the selected entity group.

### Example 9

### Exemplary Pivot

In any of the examples herein, a pivot can be the ability to switch between different options, procedures, or techniques of accessing, displaying, navigating to, or viewing entity groups, entities, or tasks (e.g., a task template, or instance of a task template, associated with the task). For example, a user can be presented with two options for accessing a task template, and the user can pivot (e.g., switch, alternate, change) between the two options. One of the two options can represent task navigation via a context-free task list, and the other option can represent task navigation via a contextual task list.

A user can also pivot between display of an asset view and a solution view. For example, a user can select an entity group. Then, the user can pivot between an asset view and a solution view of the selected entity group. A list of tasks (e.g., contextual tasks) can also be displayed based on the selected entity group.

### Example 10

### Exemplary Alert

In any of the examples herein, an alert can be displayed in response to a selection of an entity or an entity group. An alert can represent an operational problem with the selected entity or entity group. For example, if a specific computer server entity is selected, an alert can indicate that a service (e.g., DHCP service, printing service, file sharing service) running on the selected server entity has stopped responding.

### Example 11

### Exemplary Server Applications

In any of the examples herein, server applications can be any software installed on a server. For example, server applications can include any server application offering a service for use by a client. In practice, such server applications can include file sharing services, email servers, licensing services, directory services, firewall services, anti-spam services, anti-virus detection services, networking services (e.g., services for managing identities and relationships that make up a network), and the like.

Server applications can also include operating system programs, such as an operating system, operating system enhancements, or both.

### Example 12

### Exemplary Task System

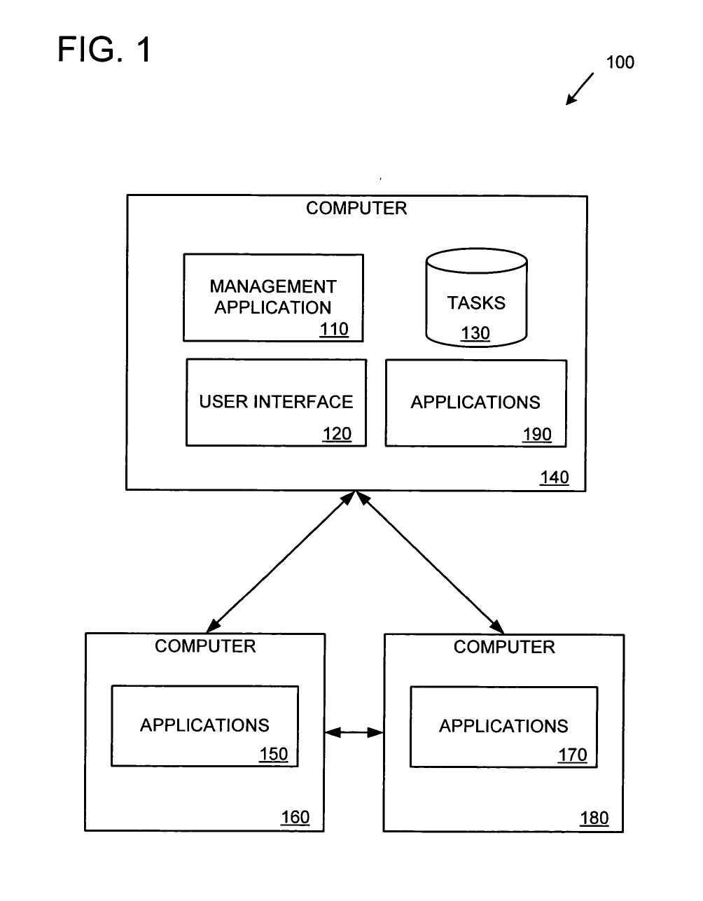

FIG. 1 shows an exemplary system 100 for using tasks. In the example, a management application 110 (e.g., a server application) can run on a computer server 140. For example, the management application 110 can be an application for managing a collection of applications (e.g., 150, 170, and 190) (e.g., a server applications) designed to operate a multi-server computer system (e.g., providing services to a business or organization). The collection of applications can include, for example, email applications, file serving applications, remote access applications, user management applications, licensing applications, and monitoring applications. Different servers of the multi-server computer system can run different applications from the collection of applications. For example, the multi-server computer system can comprise three servers: a management server (e.g., 140), an email server (e.g., 160), and a firewall server (e.g., 180). The management application 110 can be located on the management server (e.g., 140) and manage applications on the same server as well as applications on different servers (e.g., 160 and 180).

The management application 110 can be used to manage servers (e.g., by managing server applications running on the servers) using tasks 130. Tasks 130 can be stored (e.g., as task templates) in a database on a computer server (e.g., on the same server as the management application, or on a different server). Tasks 130 can also be stored in other ways (e.g., in a flat file, on removable media, as an XML schema).

The management application 110 can provide a user interface 120 allowing a user to access tasks 130. For example, the user interface 120 of the management application 110 can display tasks 130 (e.g., displayed as user interface elements for initiating the tasks) in a variety of forms, such as a context-free task list or a contextual task list. The user interface 120 can also display entities and entity groups. For example, a user can select an entity or entity group from the user interface 120 to display contextual tasks.

From the user interface 120, a user can select (e.g., invoke) a task 130 (e.g., by selecting a user interface element for initiating the task) to manage (e.g., display information from, make a change to) an application. For example, the user can select a task 130 to manage applications 190 on the same computer server 140 that the management application 110 is operating on. The user can also select a task 130 to manage an application on a different computer server (e.g., manage applications 150 on a computer server 160, or manage applications 170 on computer server 180).

The user interface 120 can also support different options, procedures, or techniques for navigating to tasks 130 (e.g., navigating to task templates associated with, and used to accomplish, the tasks). For example, the user interface 120 can support an option for navigating to a task by displaying a context-free task (e.g., displaying a context-free task on a home page of the user interface 120 where the user has not selected an entity or entity group). The user interface 120 can support an option for navigating to a task based on a selection of an entity group and then displaying a contextual task. The user interface 120 can also support an option for navigating to a task based on a selection of an entity from an entity group and then displaying a contextual task.

### Example 13

### Exemplary Method for Presenting Options to Navigate to a Task Template

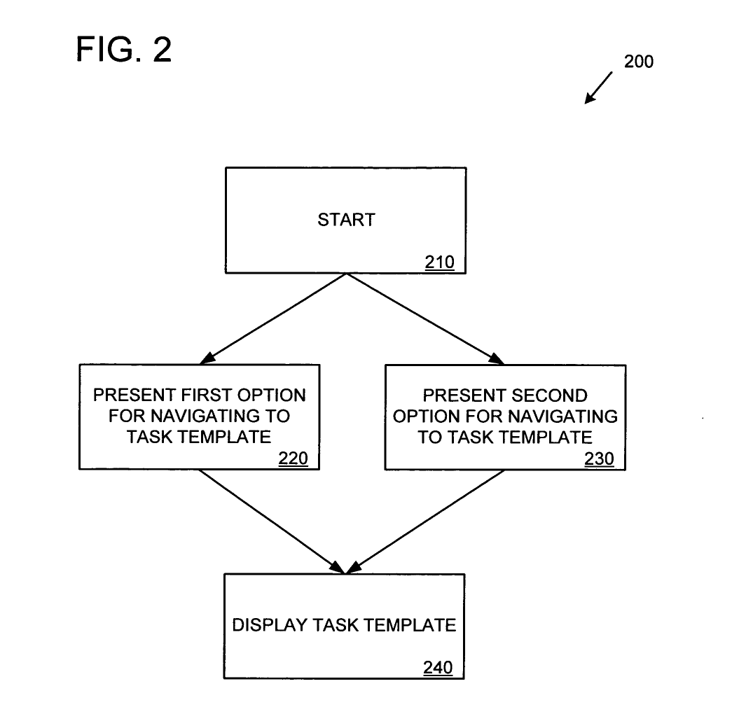

FIG. 2 shows an exemplary method 200 for navigating to a task template by presenting a user with a first and second option, and can be performed, for example, by a system such as that shown in FIG. 1. At 210, the method starts, and the user is presented with a first and second option. At 220, a first option is presented for navigating to a task template. At 230, a second different option is presented for navigating to the task template. Regardless of which option the user selects, at 240 the task template is displayed.

By providing two options to navigate to a task template (e.g., the same task template), a user can chose (e.g., pivot between) the most efficient or most appropriate (e.g., familiar) option. For example, a user can be presented, as a first option, with a list of context-free tasks. A user can also be presented, as a second option, with a list of contextual tasks associated with a selected entity group or entity.

### Example 14

### Exemplary User Interface Depicting Entity Groups

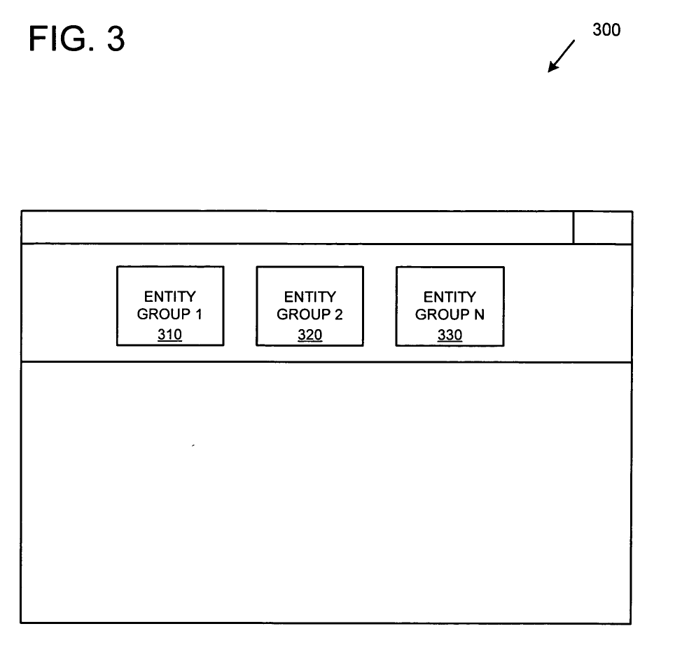

FIG. 3 shows an exemplary user interface 300 depicting entity groups. The user interface can be displayed, for example, by a system such as that shown in FIG. 1. In the user interface 300, a variable (e.g., arbitrary) number of entity groups can be displayed (e.g., 310, 320, and 330). For example, one of the entity groups (e.g., 310) can be a network entity group. Another of the entity groups (e.g., 320) can be a users entity group. And, another of the entity groups (e.g., 330) can be a licensing entity group.

The user interface 300 can be displayed by a management application running on a computer server (e.g., a computer server of a multi-server system). The user interface 300 can support various options for navigating to tasks for use in managing various applications (e.g., running on different computer servers of a multi-server system).

An entity group (e.g., 310, 320, or 330) can be selected by a user. Based on the selected entity group, one or more contextual tasks can be displayed (e.g., displayed as user interface elements for initiating the tasks). For example, if the user selects a network entity group, then a contextual task, such as monitoring performance on the network, can be displayed. Instead of, or in addition to, displaying contextual tasks, context-free tasks can also be displayed (e.g., displayed as user interface elements for initiating the tasks) in the user interface 300 (e.g., when the entity groups are unselected).

### Example 15

### Exemplary User Interface Depicting Context-Free Tasks

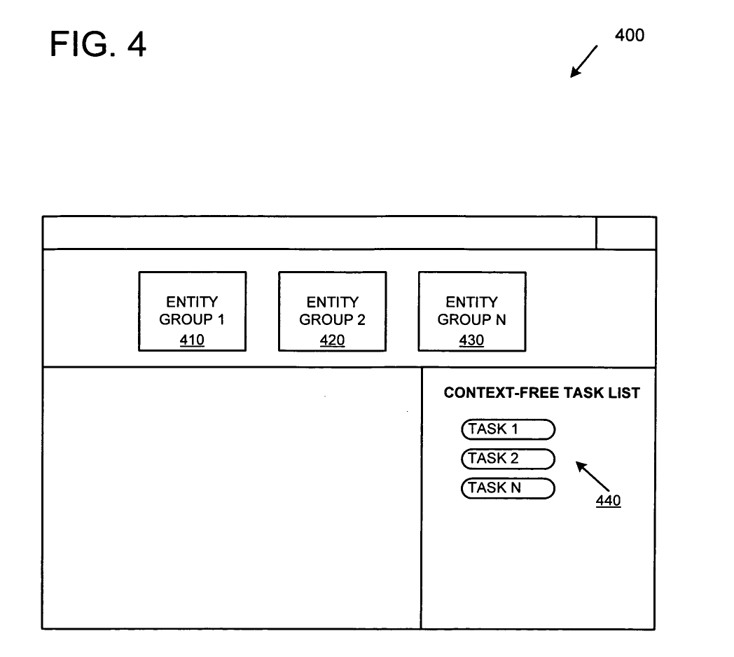

FIG. 4 shows an exemplary user interface 400 depicting a context-free task list 440. The user interface can be displayed, for example, by a system such as that shown in FIG. 1. In the user interface 400, a variable (e.g., arbitrary) number of entity groups can be displayed (e.g., 410, 420, and 430). For example, one of the entity groups (e.g., 410) can be a network entity group. Another of the entity groups (e.g., 420) can be a users entity group. And, another of the entity groups (e.g., 430) can be a licensing entity group.

Also displayed in the user interface 400 is a context-free task list 440. The context-free task list 440 can comprise a variable (e.g., arbitrary) number of context-free tasks (e.g., one or more context-free tasks). The context-free task list 440 can be represented by a title.

The context-free task list 440 can be displayed and accessed in various ways. For example, the context-free task list 440 can be displayed on a home page of a management application. The context-free task list 440 can be accessed via a descriptive link or button. For example, the context-free task list 440 can be accessed via a “critical alerts” link or via a “recommended tasks” link (e.g., the links can display a pop-up window containing the context-free task list 440, or the links can cause display of the context-free task list 440 somewhere in the same window).

The context-free task list 440 can be a recommended tasks list. Recommended tasks can be tasks that are recommended based on information obtained by a management application (e.g., performance information, licensing information, error condition information). For example, a recommended task can be displayed (e.g., in the context-free task list 440) when there is a license compliance issue (e.g., when available licenses have been exceeded for accessing an email service). A recommended task can also be displayed, for example, when updates need to be approved (e.g., for software, such as an operating system, running on a computer server).

### Example 16

### Exemplary User Interface Depicting Contextual Tasks

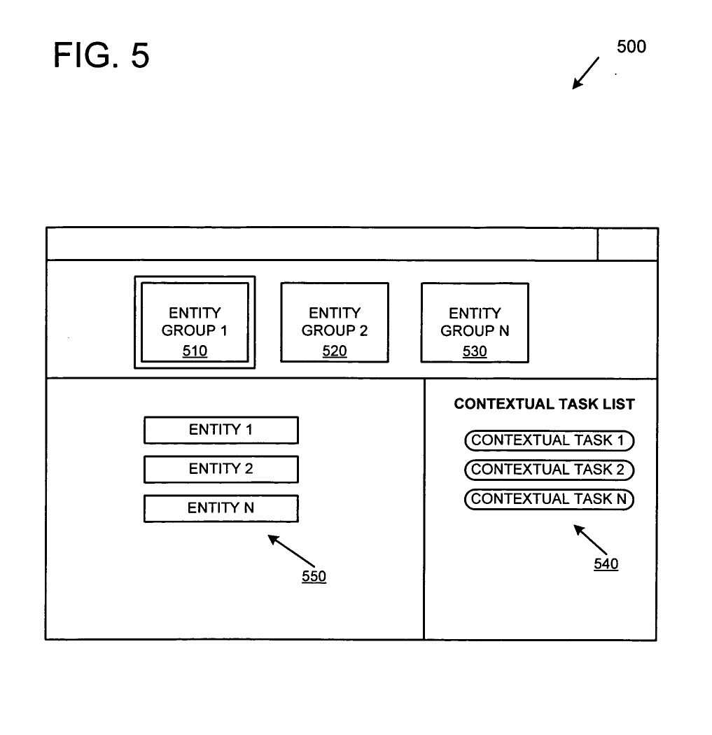

FIG. 5 shows an exemplary user interface 500 depicting a contextual task list. The user interface can be displayed, for example, by a system such as that shown in FIG. 1. In the user interface 500, a variable (e.g., arbitrary) number of entity groups can be displayed (e.g., 510, 520, and 530). For example, one of the entity groups (e.g., 510) can be a network entity group. Another of the entity groups (e.g., 520) can be a users entity group. And, another of the entity groups (e.g., 530) can be a licensing entity group.

A user can select one of the entity groups (e.g., 510, 520, and 530). In the user interface, the user has selected entity group 510. In response to the selection of entity group 510, one or more entities 550 comprising the entity group 510 are displayed. For example, the selected entity group 510 can be a network entity group, and the one or more entities 550 comprising the network entity group can be one or more computer servers (e.g., listed by server name and IP address).

The one or more entities 550 can be presented in a variety of ways. For example, the entities 550 can be presented in a list view (e.g., as rows of information). The entities 550 can also be presented in a topology view (e.g., as a graphical representation of the entities).

In response to a selection of an entity group, a contextual task list can be displayed. In the user interface 500, the selection of the entity group 510 has resulted in display of the contextual task list 540. The contextual task list 540 can comprise a variable (e.g., arbitrary) number of contextual tasks (e.g., one or more contextual tasks). The contextual task list 540 can be represented by a title (e.g., network tasks, server tasks, user tasks, licensing tasks).

The contextual task list 540 can be displayed and accessed in various ways. The contextual task list 540 can be displayed in separate area of the user interface 500. The contextual task list 540 can also be displayed in a pop-up window (e.g., as the result of a user clicking or right-clicking on an entity group). The contextual task list 540 can be accessed via a descriptive link or button.

### Example 17

### Exemplary User Interface Depicting Context-Free Tasks and Contextual Tasks

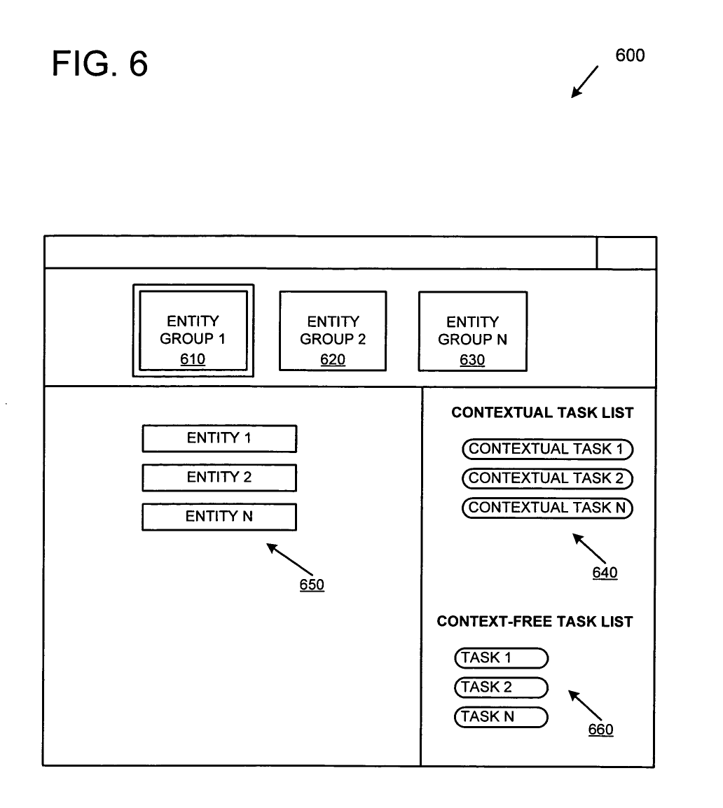

FIG. 6 shows an exemplary user interface 600 depicting a context-free task list and a contextual task list. The user interface can be displayed, for example, by a system such as that shown in FIG. 1. In the user interface 600, a variable (e.g., arbitrary) number of entity groups can be displayed (e.g., 610, 620, and 630). For example, one of the entity groups (e.g., 610) can be a network entity group. Another of the entity groups (e.g., 620) can be a users entity group. And, another of the entity groups (e.g., 630) can be a licensing entity group.

In the user interface 600, an entity group 610 has been selected. Based on the selected entity group 610, one or more entities are displayed 650. Also based on the selected entity group 610, a list of contextual tasks is displayed 640. Also displayed in the user interface is a list of context-free tasks 660. The contextual tasks 640 and context-free tasks 660 can be displayed in the user interface at the same time (e.g., simultaneously, concurrently, contemporaneously).

The contextual tasks 640 can be associated with a title (e.g., server tasks). The context-free tasks 660 can also be associated with a title (e.g., recommended tasks). The contextual tasks 640 and context-free tasks 660 can occupy different areas of the user interface. They can also be displayed together (e.g., mixed together in a single list).

### Example 18

### Exemplary User Interface Depicting Contextual Tasks Associated with an Entity

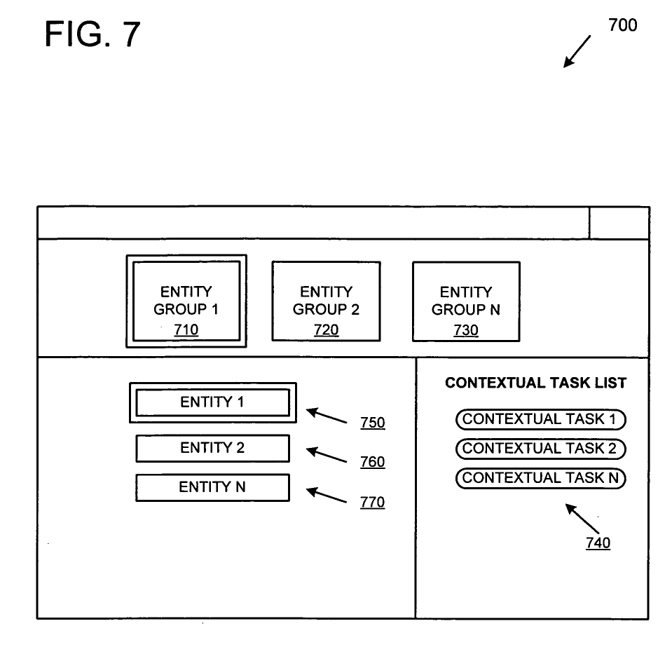

FIG. 7 shows an exemplary user interface 700 depicting a contextual task list associated with an entity. The user interface can be displayed, for example, by a system such as that shown in FIG. 1. In the user interface 700, an entity group 710 has been selected (e.g., by a user from a number of entity groups, such as 710, 720, and 730). Based on the selected entity group 710, a number of entities are displayed: 750, 760, and 770. For example, the entity group 710 can be a network entity group, and the entities 750-770 can be computer server entities.

In the user interface 700, an entity 750 has been selected. Based on the selected entity 750, a contextual task list is displayed 740. The contextual task list 740 can be associated with the selected entity 750. For example, if the selected entity 750 is a computer server, the contextual task list 740 can comprise tasks to be performed on the selected computer server, such as: configure web server, approve an update, and deploy software package.

The contextual task list 740 can be displayed in a variety of ways. For example, the contextual task list 740 can be displayed when clicking or right-clicking on the entity 750. The contextual task list 740 can also be displayed in a pop-up window, or as a list in a portion of a window (e.g., the same window in which the entity 750 is displayed).

### Example 19

### Exemplary User Interface Depicting Specific Context-Free Tasks

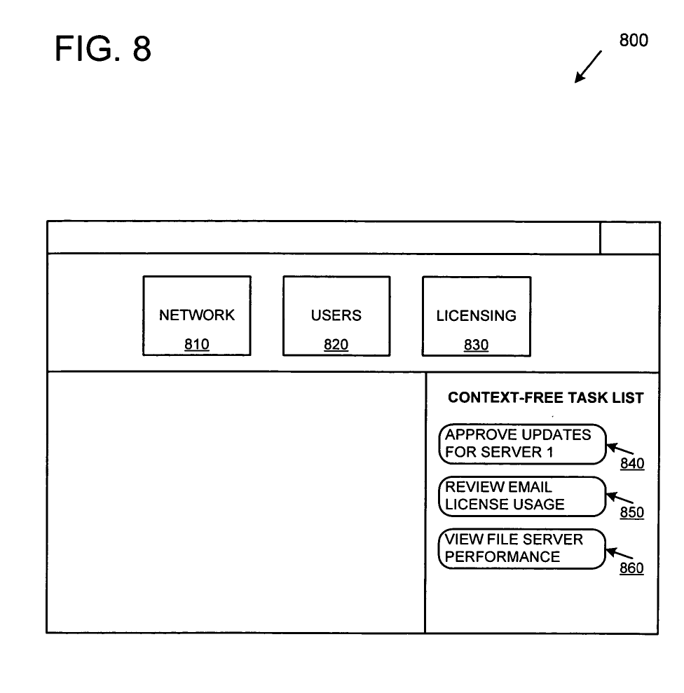

FIG. 8 shows an exemplary user interface 800 depicting a specific context-free task list. The user interface can be displayed, for example, by a system such as that shown in FIG. 1. In the user interface 800, a number of entity groups are displayed: a network entity group 810, a users entity group 820, and a licensing entity group 830. In the user interface 800, none of the entity groups have been selected.

In the user interface 800, a number of context-free tasks are displayed: an “approve updates for server 1” task 840, a “review email license usage” task 850, and a “view file server performance” 860 task. These tasks are context-free because they are not associated with the context of a selected entity group or entity. The context-free tasks (840-860) can comprise a recommended task list.

### Example 20

### Exemplary User Interface Depicting Specific Contextual Tasks

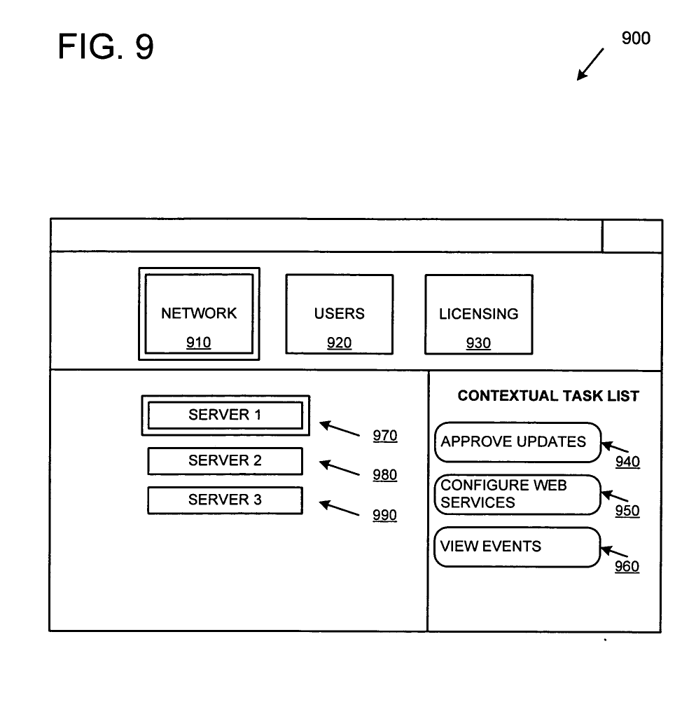

FIG. 9 shows an exemplary user interface 900 depicting a specific contextual task list associated with a selected entity. The user interface can be displayed, for example, by a system such as that shown in FIG. 1. In the user interface 900, a number of entity groups are displayed: a network entity group 910, a users entity group 920, and a licensing entity group 930.

In the user interface 900, the network entity group 910 has been selected (e.g., by a user). Based on the selected network entity group 910, three server entities have been displayed 970-990.

In the user interface 900, the “server 1” entity 970 has been selected (e.g., by a user). Based on the selected entity 970, a contextual task list has been displayed 940-960. The tasks 940-960 are contextual because they are associated with the selected entity 970. For example, the “approve updates” contextual task 940 will allow a user to approve updates for “server 1” 970 (the selected entity). Similarly, the “configure web services” contextual task 950 will allow a user to configure web services on “server 1” 970. Finally, the “view events” contextual task 960 will allow a user to view events for “server 1” 970.

The contextual tasks 940-960 can be displayed in a variety of ways. For example, they can be displayed (e.g., in a pop-up menu or window) when clicking or right-clicking on the selected entity 970. They can also be displayed as a list in the user interface 900.

### Example 21

### Exemplary User Interface Depicting a Topology View

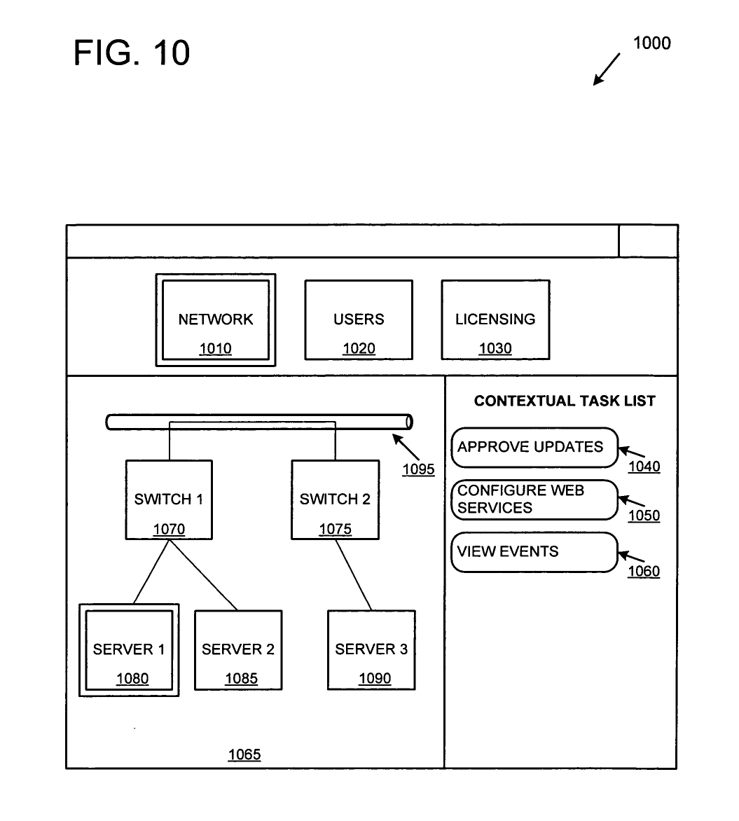

FIG. 10 shows an exemplary user interface 1000 depicting a topology view 1065 of entities. The user interface can be displayed, for example, by a system such as that shown in FIG. 1. In the user interface 1000, a number of entity groups are displayed: a network entity group 1010, a users entity group 1020, and a licensing entity group 1030. In the user interface 1000, the network entity group 1010 has been selected.

Based on the selection of the network entity group 1010, a number of entities associated with the network entity group are displayed 1070-1095. The entities 1070-1095 are displayed in a topology view 1065. The topology view 1065 displays the entities as a graphical representation of the entities (e.g., displaying relationships between the entities). In the user interface 1000, a number of computer servers 1080-1090 are visually displayed as connected to network switches 1070 and 1075. The network switches 1070 and 1075 are visually displayed as connected via a network medium 1095 (e.g., a local area network).

Displaying entities in a topology view can provide advantages over displaying entities in a list view. For example, a topology view can visually depict relationships between entities (e.g., visually display how network devices are connected together in a network).

A topology view can also provide a real-time representation of entities. For example, a topology view of printers can display (e.g., in real-time or near real-time) the users connected to the printer (e.g., users who have printing jobs actively printing or queued up to print on the printer). In addition, a topology view of printers can display (e.g., in real-time or near real-time) an error condition (e.g., an operational problem) with a printer (e.g., by displaying a visual indication of the error such as a red “X” on the printer). In response to the error condition, a task can be displayed (e.g., a contextual task can be displayed when the user clicks on the printer) to troubleshoot or fix the printer. A context-free task can also be displayed in response to the error condition.

A topology view can also display tasks (e.g., contextual tasks) related to the real-time condition of the entity. For example, a topology view displaying printers can display a contextual task to fix a broken printer (e.g., a printer that has stopped responding to print requests).

### Example 22

### Exemplary User Interface Depicting Assets

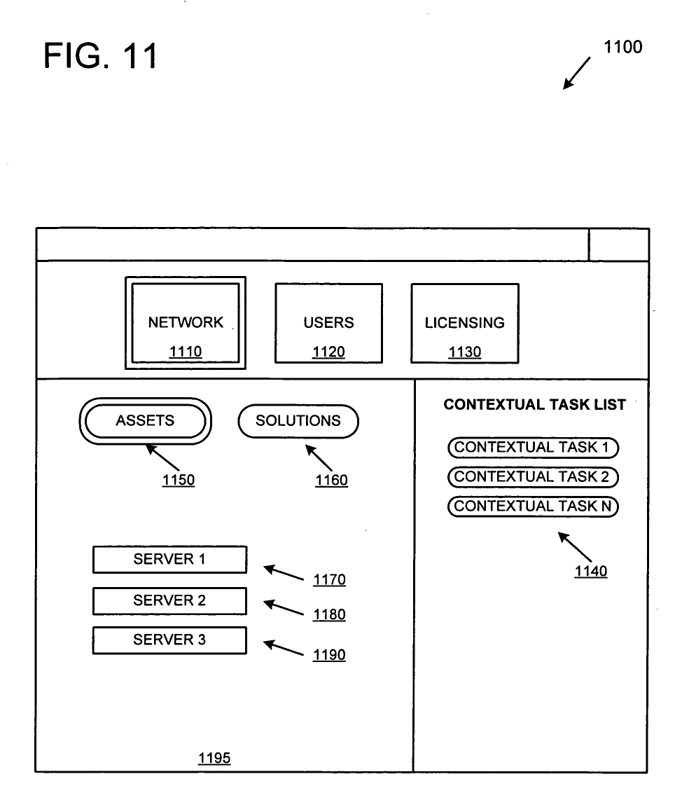

FIG. 11 shows an exemplary user interface 1100 depicting assets. The user interface can be displayed, for example, by a system such as that shown in FIG. 1. In the user interface 1100, a number of entity groups are displayed: a network entity group 1110, a users entity group 1120, and a licensing entity group 1130. In the user interface 1100, the network entity group 1110 has been selected.

At 1195, an area of the user interface (e.g., a view) is displayed that allows a user to select between two different ways of viewing the selected network entity group 1110. The user can select to view the selected network entity group 1110 using an assets view 1150 or a solutions view 1160.

In the user interface 1100, the assets view 1150 has been selected. Because the assets view 1150 has been selected, assets associated with the network entity group are displayed. In this case, three computer servers (e.g., computer server entities) are displayed 1170-1190 as assets associated with the selected network entity group 1110.

Based on the selection of the assets view 1150, a contextual task list is displayed 1140. The contextual task list 1140 is associated with the assets of the selected network entity group 1110. The user can also select one of the displayed assets 1170-1190 which can cause display of a contextual task list associated with the selected asset.

### Example 23

### Exemplary User Interface Depicting Solutions

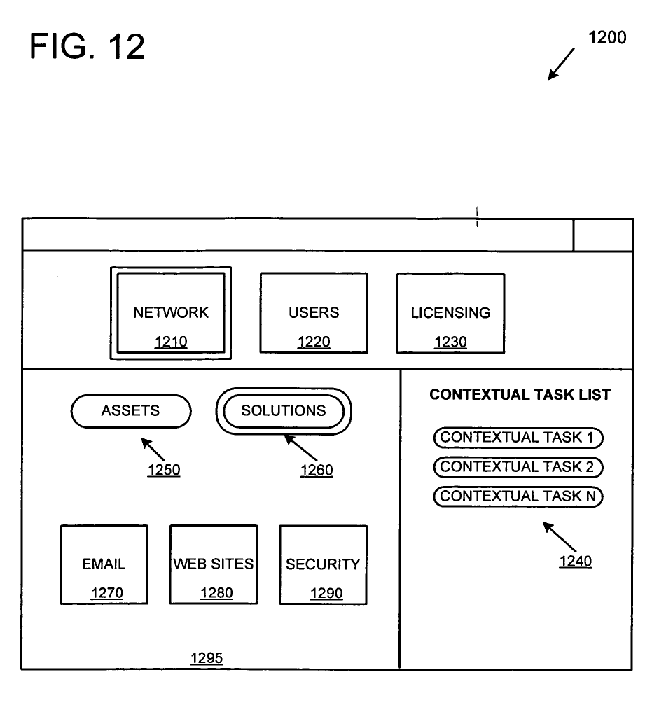

FIG. 12 shows an exemplary user interface 1200 depicting solutions. The user interface can be displayed, for example, by a system such as that shown in FIG. 1. In the user interface 1200, a number of entity groups are displayed: a network entity group 1210, a users entity group 1220, and a licensing entity group 1230. In the user interface 1200, the network entity group 1210 has been selected.

At 1295, an area of the user interface (e.g., a view) is displayed that allows a user to select between two different ways of viewing the selected network entity group 1210. The user can select to view the selected network entity group 1210 using an assets view 1250 or a solutions view 1260.

In the user interface 1200, the solutions view 1260 has been selected. Because the solutions view 1260 has been selected, solutions associated with the network entity group are displayed. In this case, three solutions are displayed: an email solution 1270, a web sites solution 1280, and a security solution 1290. The solutions depicted can themselves be selected, and selecting a solution can result in display of a number of sub-solutions. For example, the user can select the email solution 1270, and doing so can result in display of email sub-solutions (e.g., email accounts, email server settings, anti-spam/anti-virus settings).

Based on the selection of the solutions view 1260, a contextual task list is displayed 1240. The contextual task list 1240 is associated with the solutions of the selected network entity group 1210. The user can also select one of the displayed solutions 1270-1290 which can cause display of a contextual task list associated with the selected solution.

### Example 24

### Exemplary Method for Navigating to a Task Template using a User Interface

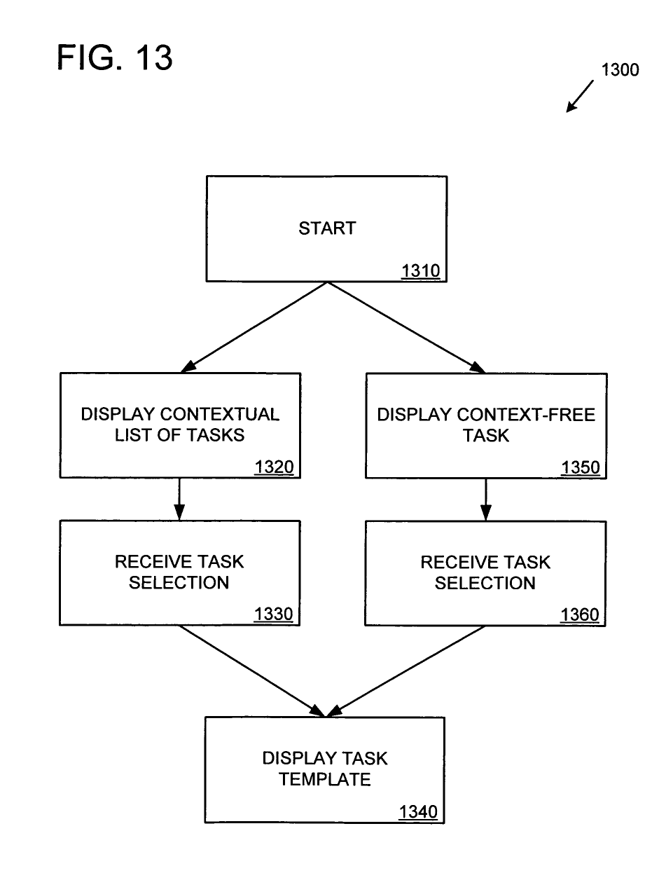

FIG. 13 shows an exemplary method 1300 for navigating to a task template using a user interface, and can be performed, for example, by a system such as that shown in FIG. 1. At 1310, the method starts, and a user is presented with a first and second option for navigating to the task template. At 1320, the user is presented with the first option for navigating to a first instance of the task template by displaying, in the user interface, a contextual list of tasks 1320, where the tasks of the contextual list of tasks are represented in the user interface by user interface elements for initiating the respective tasks (e.g., represented by user interface elements such as buttons or links).

For example, the contextual list of tasks can be displayed based on a selection, by the user, of an entity group, or based on a further selection of an entity after selecting the entity group. The contextual list of tasks can be displayed as a list view or as a topology view. The contextual list of tasks can also be displayed based on a selection of a solution (e.g., a collection of heterogeneous entities) or an asset. For example, the solution can be a networking solution comprising a collection of networking-related entities (e.g., switches, hubs, servers, firewalls, routers).

Before displaying the contextual list of tasks at 1320, entity groups can be displayed, and one of the entity groups can be selected. After the entity group has been selected, user interface controls (e.g., buttons, links, icons) can be displayed which allow the user to select between an asset view or a solution view of the selected entity group. If the asset view is selected, a number of homogeneous entities can be displayed. The contextual list of tasks 1320 can then be associated with a selection from the homogeneous entities. If the solution view is selected, a number of heterogeneous entities can be displayed. The contextual list of tasks 1320 can then be associated with a selection from the heterogeneous entities.

At 1330, a selection of a task (e.g., of a user interface element for initiating a task) from the contextual list of tasks 1320 is received via the user interface. At 1340, the task template (associated with the selected contextual task) is displayed as a first instance of the task template.

At 1350, the user is presented with the second option for navigating to a second instance of the task template by displaying, in the user interface, a context-free task, where the context-free task is represented in the user interface by a user interface element for initiating the task (e.g., represented by a user interface element such as a button or a link). For example, the context-free task can be displayed as one of a number of context-free tasks in a recommended task list.

At 1360, a selection of the context-free task (e.g., of a user interface element for initiating the context-free task) is received via the user interface. At 1340, the task template (associated with the selected context-free task) is displayed as a second instance of the task template.

Depending on which option the user selects, the other option may not be available. For example, if the user selects an entity group and based on the selected entity group a contextual list of tasks is displayed 1320, the second option comprising displaying a context-free task 1350 may not be available (e.g., it may be removed from the user interface, or it may not be presented to the user). Or, both options can be presented to the user at the same time (e.g., simultaneously, concurrently, contemporaneously).

Once the user has navigated to the task template (e.g., the instance of the task template is displayed), the user can complete the task. For example, if the user selected a task to add a new user, the instance of the task template can be a user interface displaying a form comprising a number of fields to be completed for adding the new user (e.g., user name, real name, password). The user can complete the task by completing the form.

As the exemplary method 1300 shows, a user can be presented with two different options for navigating to (e.g., selecting and displaying) the same task template.

### Example 25

### Exemplary Method for Visually Switching Between Procedures for Providing Access to a Task Template

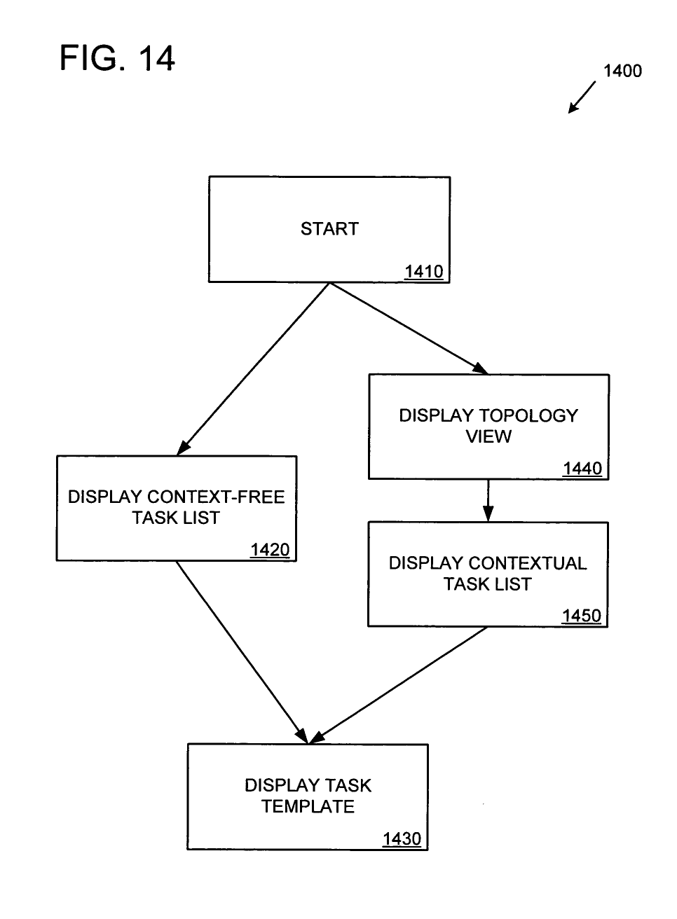

FIG. 14 shows an exemplary method 1400 for visually switching between two procedures for providing access to a task template using a user interface, and can be performed, for example, by a system such as that shown in FIG. 1. At 1410, the method starts.

At 1420, a context-free task list is displayed in the user interface, where the tasks of the context-free task list are represented in the user interface by user interface elements for invoking the respective tasks. By selecting a context-free task from the context-free task list (e.g., selecting a user interface element for invoking a context-free task from the context-free task list), the task template (e.g., a first instance of the task template) can be displayed 1430.

At 1440, a topology view of a number of entities (e.g., related entities) is displayed in the user interface. For example, the topology view can be displayed as a result of a user selecting an entity group. The topology view can also be displayed as a result of a user selecting an assets or a solutions view (or an asset or a solution).

At 1450, a contextual task list is displayed in response to a selection of an entity from the topology view by a user, where the tasks of the contextual task list are represented in the user interface by user interface elements for invoking the respective tasks. The contextual task list can be associated with the selected entity. By selecting a contextual task from the contextual task list (e.g., selecting a user interface element for invoking a contextual task from the contextual task list), the task template (e.g., a second instance of the task template) can be displayed 1430.

A first procedure for providing access to the task template can comprise displaying the context-free task list 1420 and then displaying the task template 1430 in response to a selection of a context-free task. A second procedure for providing access to the task template can comprise displaying the topology view 1440, displaying the contextual task list 1450 in response to a selection of an entity from the topology view, and finally displaying the task template 1430 in response to a selection of a task from the contextual task list.

A user can visually switch between the first and second procedures. For example, the user can decide between accessing the task template by using the first procedure (selecting a context-free task) or using the second procedure (selecting an entity from the topology view and then selecting a contextual task). Both procedures can be displayed in the user interface at the same time, or only one procedure can be displayed. For example, if the user selects an entity from the displayed topology view 1440, then the context-free task list 1420 can be removed from being displayed.

### Example 26

### Exemplary Method Supporting Two Techniques for Task Navigation

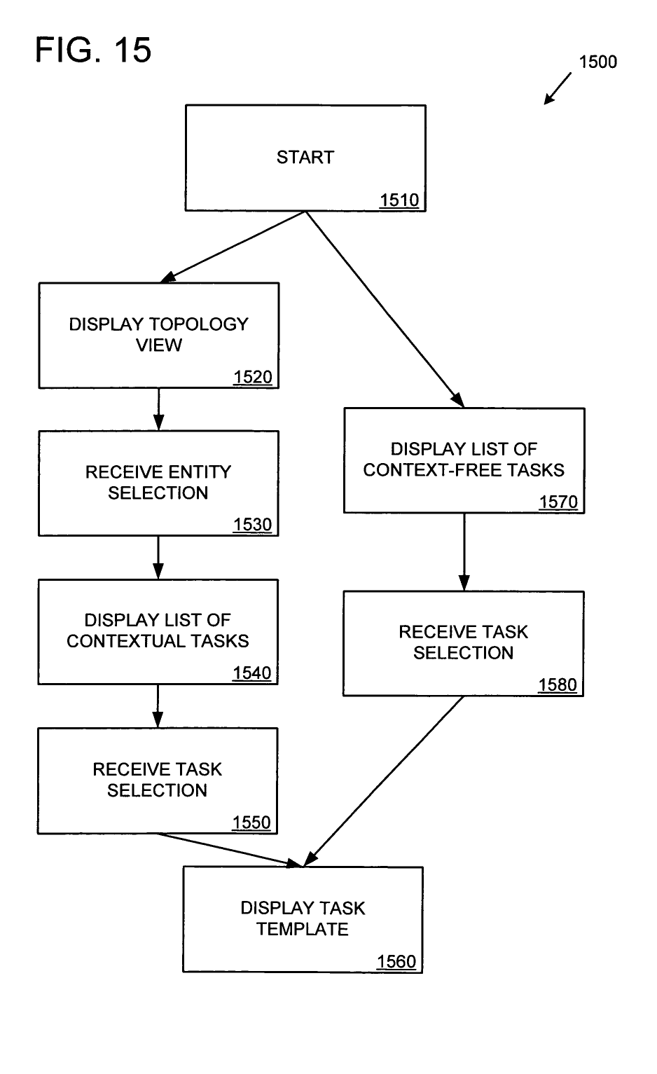

FIG. 15 shows an exemplary method 1500 supporting two techniques for task navigation, and can be performed, for example, by a system such as that shown in FIG. 1. At 1510, the method starts, and a user is presented with a first and second technique for task navigation.

Regarding the first technique, at 1520 a topology view of one or more entities is displayed. For example, the topology view can be displayed in response to a user selecting an entity group. At 1530, an entity selection from the topology view is received.

At 1540, a list of contextual tasks associated with the selected entity from the topology view is displayed, where the tasks of the list of contextual tasks are represented in the user interface by user interface elements for initiating the respective tasks. At 1550, a selection of a task from the list of contextual tasks (e.g., a selection of a user interface element for initiating a task from the list of contextual tasks) is received. At 1560, a task template associated with the selected task from the list of contextual tasks is displayed (e.g., an instance of the task template is displayed).

Regarding the second technique, at 1570, a list of context-free tasks is displayed, where the tasks of the list of context-free tasks are represented in the user interface by user interface elements for initiating the respective tasks. For example, the list of context-free tasks can be displayed when there are no selected entities or entity groups. The list of context-free tasks can also be displayed when there is a selected entity group, or a selected entity and a selected entity group.

At 1580, a selection of a task from the list of context-free tasks (e.g., a selection of a user interface element for initiating a task from the list of context-free tasks) is received. At 1560, a task template associated with the selected task from the list of context-free tasks is displayed (e.g., an instance of the task template is displayed).

The task template 1560 can be the same task template regardless of whether the task template 1560 has been navigated to by way of the first or the second technique.

The selected task from the list of contextual tasks 1550 can be the same task (e.g., the identical task) as the task selected form the list of context-free tasks. For example, the same task can be a task for approving updates for a specific computer server.

### Example 27

### Exemplary Method for Completing a Task

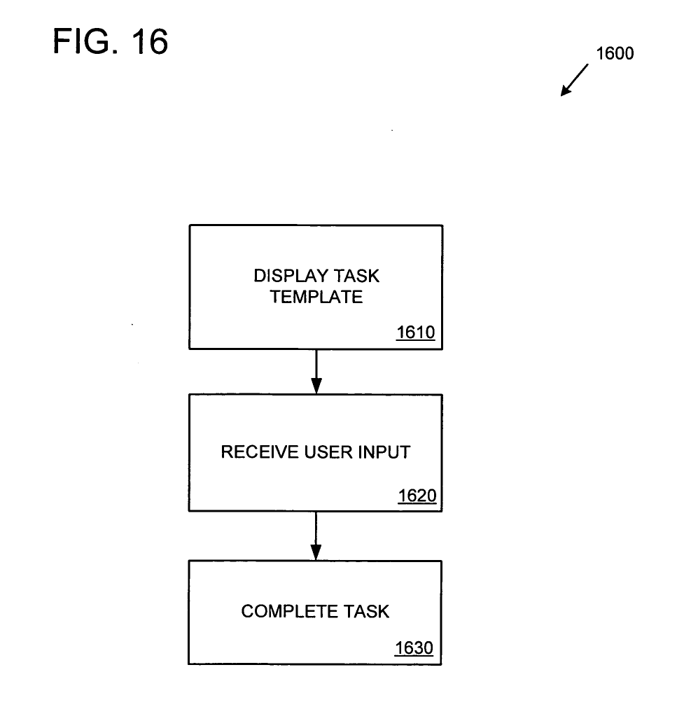

FIG. 16 shows an exemplary method 1600 for completing a task. At 1610, a task template is displayed (e.g., as an instance of the task template). For example, the task template can be displayed as a result of a user selecting a context-free task from a user interface. The task template can also be displayed as a result of a user selecting a contextual task from a user interface (e.g., after having selected an entity group, entity, asset, or solution).

At 1620, user input is received. For example, the user input can comprise information entered by the user into a form (e.g., information such as user name, real name, and password entered in an add new user form).

At 1630, the task is completed. For example, the user can complete an add new user task by entering information into a form and clicking on an “add” or “ok” button.

### Example 28

### Exemplary Multi-Server System for Performing Tasks

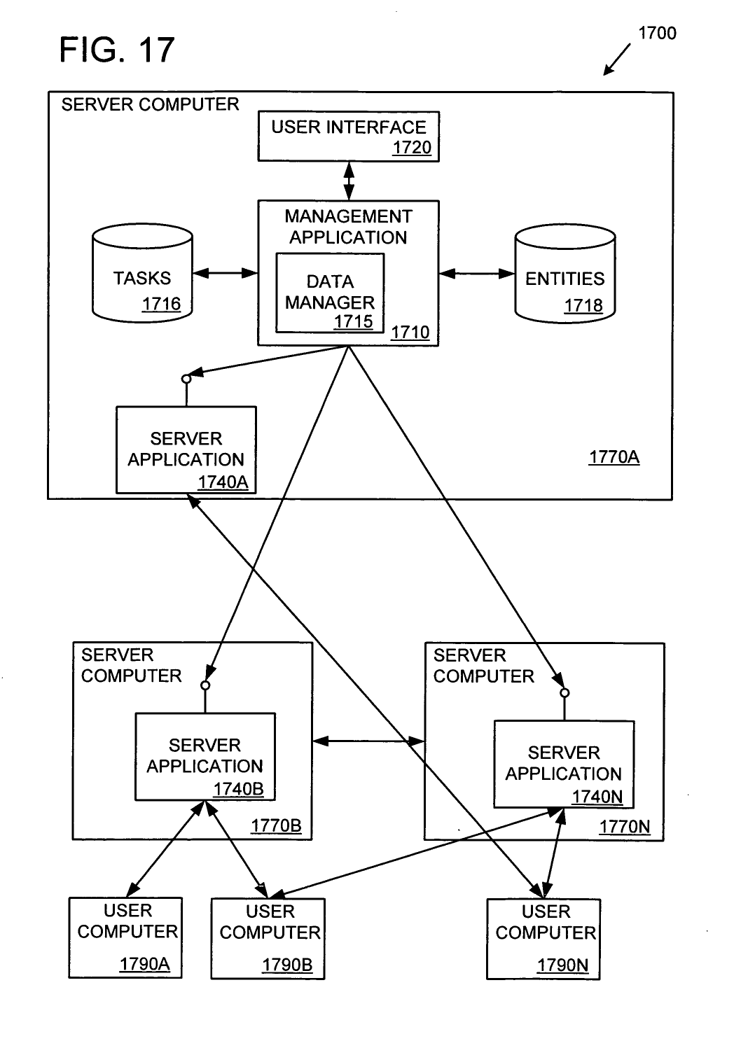

FIG. 17 shows an exemplary multi-server system 1700 for performing tasks. In the example, a management application 1710 (e.g., a server application) can run on a computer server 1770A. For example, the management application can comprise a data manager 1715 for managing a number of computer servers by managing server applications on the computer servers (e.g., server application 1740A on server 1770A, server application 1740B on server 1770B, and server application 1740N on server 1770N).

The server applications (1740A-1740N) can include, for example, server applications for providing computer services to a business or organization, such as: email applications, file serving applications, remote access applications, user management applications, licensing applications, anti-virus applications, and monitoring applications. Different servers of the multi-server system can perform specific services for a business or organization by running different server applications. For example, the multi-server system can comprise three servers: a management server (e.g., 1770A) running a file service application (e.g., 1740A), an email server (e.g., 1770B) running an email application (e.g., 1740B), and a firewall server (e.g., 1770N) running an anti-virus application (e.g., 1740N).

The data manager 1715 can manage a server application (e.g., 1740A, 1740B, or 1740N) on a server (e.g., 1770A, 1770B, or 1770N) by communicating with an API of the server application. For example, a user management server application can provide an API for displaying various user interfaces within the user management application (e.g., a user interface for adding users, a user interface for deleting users, and a user interface for resetting a user's password).

The management application 1710 can provide a user interface 1720 allowing a user to manage the servers and applications of the multi-server system 1700 using tasks 1716. For example, the user interface 1720 of the management application 1710 can display tasks 1716 (e.g., displayed as user interface elements for initiating the tasks) in a variety of forms, such as a context-free task list or a contextual task list. The user interface 1720 can also display entities and entity groups (e.g., from an entities database 1718). For example, a user can select an entity or entity group from the user interface 1720 to display contextual tasks.

The tasks 1716 can be stored (e.g., as task templates) in a database. The task templates can be used to accomplish (e.g., complete) a task by directing a user to a user interface for accomplishing the task. For example, a task template can comprise a location variable, where the location variable represents a user interface of a server application by way of an API of the server application.

For example, the management application 1710 can display, in the user interface 1720, an entity from the entities database 1718, receive a selection of the entity from a user, display a task from the tasks database 1716, and receive a selection of the task from the user. The management application 1710 can then, via the data manager 1715, using a location variable from a task template associated with the selected task, connect to an API of a server application (e.g., 1740A, 1740B, or 1740N) and display a user interface which the user can then use to complete the selected task.

Server applications (e.g., 1740A-N) can also provide services (e.g., email services, file sharing services, user services) to user computers (e.g., 1790A-N).

### Example 29

### Exemplary User Interface Depicting an Add User Task

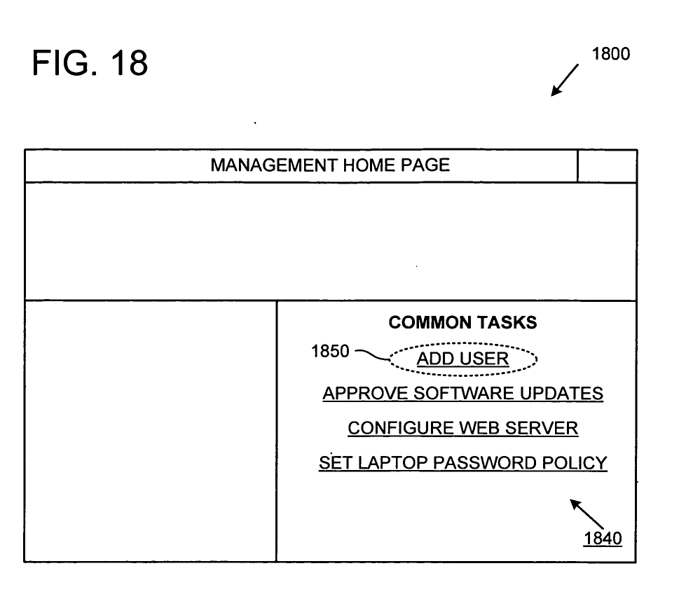

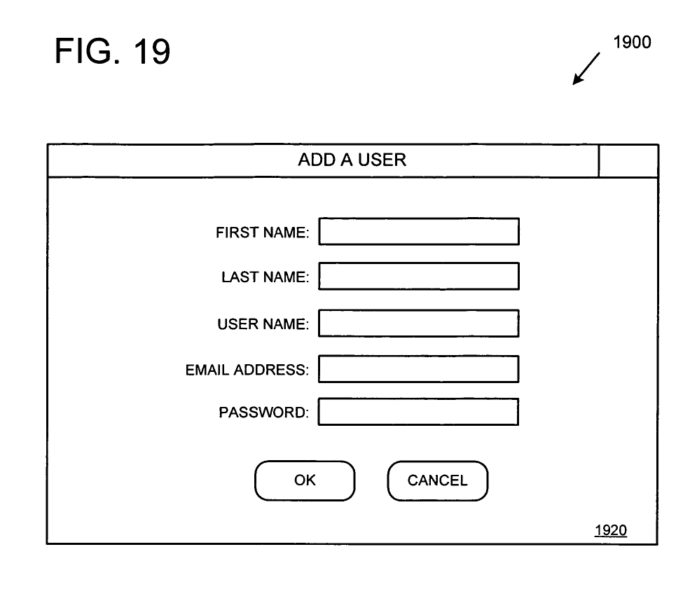

FIG. 18 shows an exemplary user interface 1800 depicting an add user task 1850. The user interface can be displayed, for example, by a system such as that shown in FIG. 17. The user interface 1800 can be the home page of a management application. As displayed in the user interface 1800, a number of context-free tasks 1840 are displayed (e.g., as user interface elements, such as links or buttons, for initiating the tasks), including an “add user” task 1850. The tasks 1840 can be associated with a title, such as “common tasks.” Selecting the “add user” task 1850 (e.g., by selecting a user interface element, such as a link or button) can initiate the task and result in display of a user interface for accomplishing the task, such as the user interface displayed in FIG. 19.

### Example 30

### Exemplary User Interface for Adding a User

FIG. 19 shows an exemplary user interface 1900 for adding a user in order to accomplish (e.g., complete) an add user task. The user interface 1900 can be displayed as a result of a user selecting an “add user” task, such as depicted in FIG. 18. A number of fields 1920 are displayed in the user interface 1900, including: first name, last name, user name, email address, and password. A user can fill in the fields and click the “OK” button in order to add a new user, and thus accomplish the task.

### Example 31

### Exemplary User Interface Depicting a Selected Users Entity Group

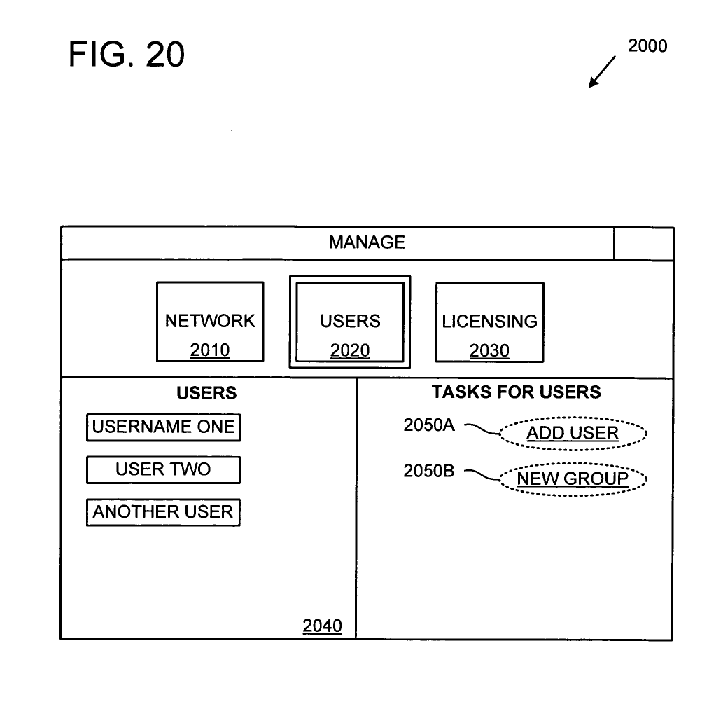

FIG. 20 shows an exemplary user interface 2000 depicting a selected users entity group. The user interface can be displayed, for example, by a system such as that shown in FIG. 17. The user interface 2000 can be displayed by a management application. In the user interface 2000, a number of entity groups are displayed: a network entity group 2010, a users entity group 2020, and a licensing entity group 2030.

In the user interface 2000, the users entity group 2020 has been selected. Based on the selected users entity group 2020, three user entities are displayed 2040. Also, based on the selected users entity group 2020, two contextual tasks are displayed: “add user” 2050A and “new group” 2050B. The contextual tasks are associated with the selected users entity group 2020.

Selecting the “add user” task 2050A (e.g., by selecting a user interface element, such as a link or button) can initiate the task and result in display of a user interface for accomplishing the task, such as the user interface displayed in FIG. 19.

### Example 32

### Exemplary User Interface Depicting a Selected User Entity

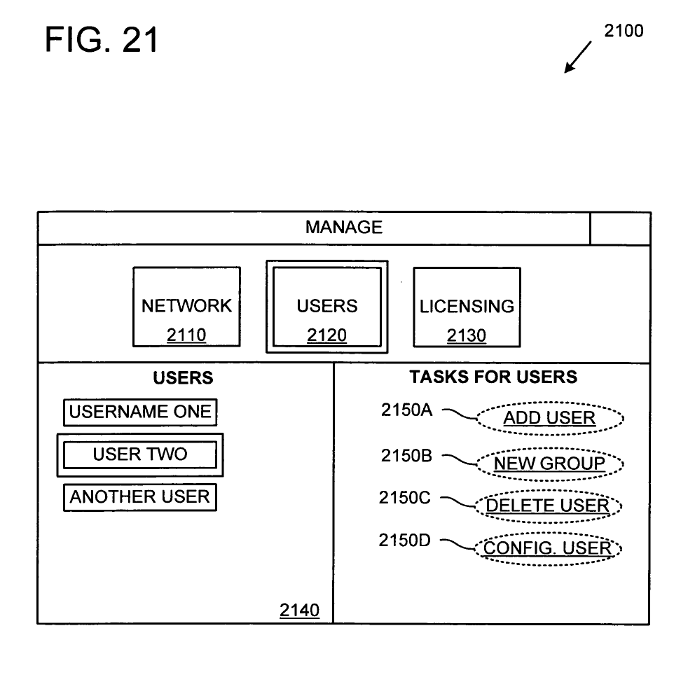

FIG. 21 shows an exemplary user interface 2100 depicting a selected user entity. The user interface can be displayed, for example, by a system such as that shown in FIG. 17. The user interface 2100 can be displayed by a management application. In the user interface 2100, a number of entity groups are displayed: a network entity group 2110, a users entity group 2120, and a licensing entity group 2130.

In the user interface 2100, the users entity group 2120 has been selected. Based on the selected users entity group 2120, three user entities are displayed 2140. One of the user entities, “user two,” has been selected 2140, and based on the selected user entity and selected user entity group, a list of contextual tasks are displayed 2150A-D. The list of contextual tasks 2150A-D are associated with the selected users entity group and the selected “user two” user entity.

Selecting the “add user” task 2150A (e.g., by selecting a user interface element, such as a link or button) can initiate the task and result in display of a user interface for accomplishing the task, such as the user interface displayed in FIG. 19.

### Example 33

### Exemplary Computing Environment

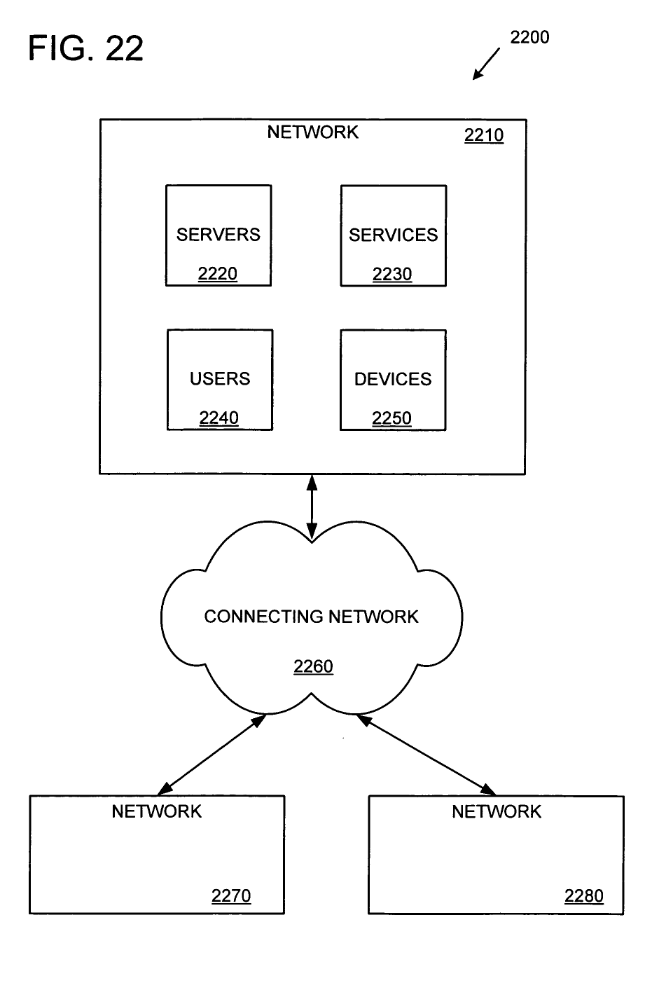

FIG. 22 illustrates an example computing environment 2200 that can be used to implement any of the technologies described herein. The computing environment includes a network 2210. The network 2210 can comprise servers 2220 (e.g., computer servers), services 2230 (e.g., computer services), users 2240 (e.g., general computer users, IT administrators, employees), and devices 2250 (e.g., desktop or laptop computers, printers, copiers, scanners).

The network 2210 can connect to other networks, such as 2270 and 2280 through in connecting network 2260. For example, the connecting network 2260 can comprise a wide area network such as the Internet or a local network. The connecting network can comprise various network hardware, protocols, and topologies.

### Example 34

### Exemplary General Purpose Computer System

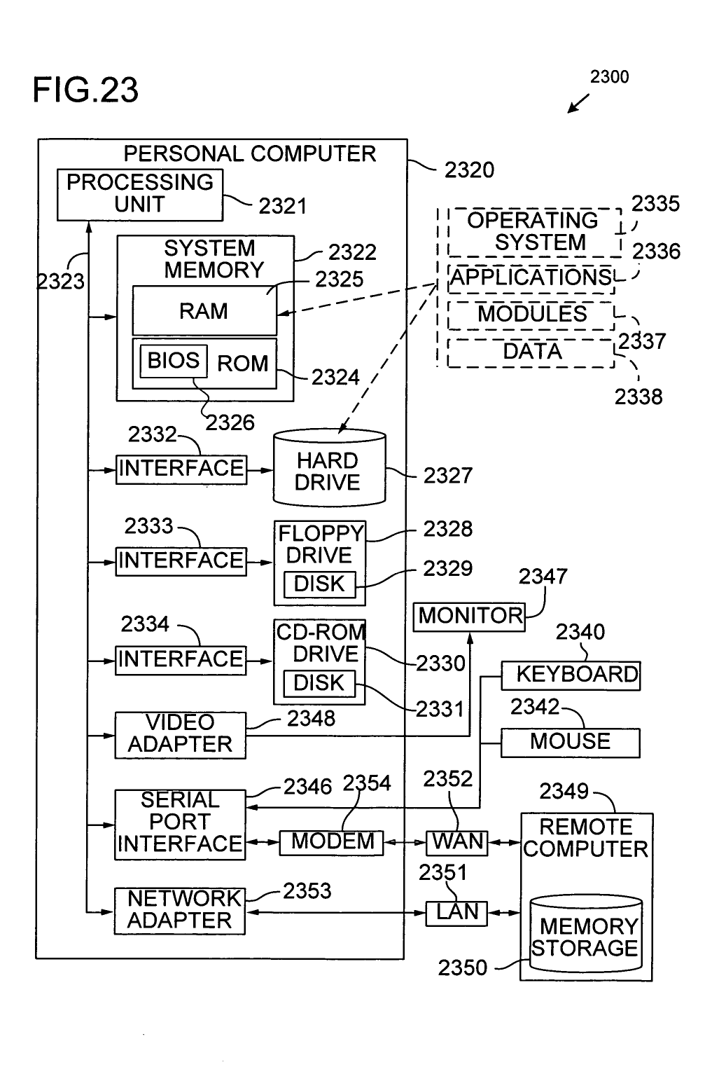

FIG. 23 illustrates an example of a computer system 2300 that can be used to implement any of the technologies described herein. The computer system includes a personal computer 2320, including a processing unit 2321, a system memory 2322, and a system bus 2323 that interconnects various system components including the system memory to the processing unit 2321. The system bus may comprise any of several types of bus structures including a memory bus or memory controller, a peripheral bus, and a local bus using a bus architecture such as PCI, VESA, Microchannel (MCA), ISA and EISA, to name a few. The system memory includes read only memory (ROM) 2324 and random access memory (RAM) 2325. A basic input/output system 2326 (BIOS), containing the basic routines that help to transfer information between elements within the personal computer 2320, such as during start-up, is stored in ROM 2324. The personal computer 2320 further includes a hard disk drive 2327, a magnetic disk drive 2328, e.g., to read from or write to a removable disk 2329, and an optical disk drive 2330, e.g., for reading a CD-ROM disk 2331 or to read from or write to other optical media. The hard disk drive 2327, magnetic disk drive 2328, and optical disk drive 2330 are connected to the system bus 2323 by a hard disk drive interface 2332, a magnetic disk drive interface 2333, and an optical drive interface 2334, respectively. The drives and their associated computer-readable media provide nonvolatile storage of data, data structures, computer-executable instructions (program code such as dynamic link libraries, and executable files), etc. for the personal computer 2320. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 2325, including an operating system 2335, one or more application programs 2336, other program modules 2337, and program data 2338. A user may enter commands and information into the personal computer 2320 through a keyboard 2340 and pointing device, such as a mouse 2342. Other input devices (not shown) may include a microphone, joystick, game pad, satellite dish, scanner, or the like. These and other input devices are often connected to the processing unit 2321 through a serial port interface 2346 that is coupled to the system bus, but may be connected by other interfaces, such as a parallel port, game port or a universal serial bus (USB). A monitor 2347 or other type of display device is also connected to the system bus 2323 via an interface, such as a display controller or video adapter 2348. In addition to the monitor, personal computers typically include other peripheral output devices (not shown), such as speakers and printers.

The personal computer 2320 may operate in a networked environment using logical connections to one or more remote computers, such as a remote computer 2349. The remote computer 2349 may be a server, a router, a peer device or other common network node, and typically includes many or all of the elements described relative to the personal computer 2320, although only a memory storage device 2350 has been illustrated in FIG. 23. The logical connections depicted in FIG. 23 include a local area network (LAN) 2351 and a wide area network (WAN) 2352. Such networking environments are commonplace in offices, enterprise-wide computer networks, intranets and the Internet.

When used in a LAN networking environment, the personal computer 2320 is connected to the local network 2351 through a network interface or adapter 2353. When used in a WAN networking environment, the personal computer 2320 typically includes a modem 2354 or other means for establishing communications over the wide area network 2352, such as the Internet. The modem 2354, which may be internal or external, is connected to the system bus 2323 via the serial port interface 2346. In a networked environment, program modules depicted relative to the personal computer 2320, or portions thereof, may be stored in the remote memory storage device. The network connections shown are merely examples and other means of establishing a communications link between the computers may be used.

### Example 35

### Exemplary Automated Methods

Any of the methods described herein can be performed via one or more computer-readable media having computer-executable instructions for performing such methods. Operation can be fully automatic, semi-automatic, or involve manual intervention.

### Example 36

### Exemplary Combinations

The technologies of any example described herein can be combined with the technologies of any one or more other examples described herein.

### Example 37

### Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer implemented method for navigating to a task template using a user interface, the method comprising:
presenting a user with a first option for navigating to a first instance of the task template, the first option comprising:
displaying a contextual list of tasks, wherein the tasks of the contextual list of tasks are represented in the user interface by user interface elements for initiating the respective tasks;
receiving, from the user via the user interface, a selection of a user interface element for initiating a task from the contextual list of tasks; and
displaying the first instance of the task template associated with the selected task from the contextual list; and
presenting the user with a second option for navigating to a second instance of the task template, the second option comprising:
displaying a context-free task, wherein the context-free task is represented in the user interface by a user interface element for initiating the task;
receiving, from the user via the user interface, a selection of a user interface element for initiating the context-free task; and
displaying the second instance of the task template associated with the selected context-free task.

2. The method of claim 1 wherein presenting the user with the first option for navigating to the first instance of the task template further comprises:
receiving, via the user interface, a selection of an entity group from the user;
wherein the contextual list of tasks is associated with the selected entity group.

3. The method of claim 1 wherein presenting the user with the first option for navigating to the first instance of the task template further comprises:
receiving, via the user interface, a selection of an entity group from the user; and
receiving, via the user interface, a selection of an entity from the entity group from the user;
wherein the contextual list of tasks is associated with the selected entity.

4. The method of claim 1 wherein presenting the user with the first option for navigating to the first instance of the task template further comprises:
displaying a plurality of entity groups;
receiving, from the user via the user interface, a selection of an entity group from the plurality of entity groups;
based on the selected entity group, displaying a plurality of entities in a topology view, wherein the plurality of entities comprise the selected entity group; and
receiving, from the user via the user interface, a selection of an entity from the plurality of entities in the topology view;
wherein the contextual list of tasks is associated with the selected entity.

5. The method of claim 1 wherein presenting the user with the first option for navigating to the first instance of the task template further comprises:
displaying a plurality of solutions;
receiving, from the user via the user interface, a selection of a solution from the plurality of solutions;
based on the selected solution, displaying a plurality of entities in a topology view, wherein the plurality of entities comprise the selected solution; and
receiving, from the user via the user interface, a selection of an entity from the plurality of entities in the topology view;
wherein the contextual list of tasks is associated with the selected entity.

6. The method of claim 5 wherein the plurality of entities comprising the selected solution are a plurality of heterogeneous entities.

7. The method of claim 5 wherein the selected solution is a networking solution, wherein the networking solution comprises a collection of entities related to networking.

8. The method of claim 1 wherein presenting the user with the first option for navigating to the first instance of the task template further comprises:
displaying a plurality of entity groups;
receiving, from the user via the user interface, a selection of an entity group from the plurality of entity groups;
displaying one or more user interface controls operable to select between an asset view and a solution view of the selected entity group;
if the user selects, via the user interface, the asset view, displaying a plurality of homogeneous entities, wherein the contextual list of tasks is related to an entity selected by the user from the plurality of homogeneous entities; and
if the user selects, via the user interface, the solution view, displaying a plurality of heterogeneous entities, wherein the contextual list of tasks is related to an entity selected by the user from the plurality of heterogeneous entities.

9. The method of claim 1 wherein the context-free task is displayed as one of a plurality of context-free tasks in a recommended task list, wherein the tasks are represented in the user interface by user interface elements for initiating the respective tasks.

10. The method of claim 1 further comprising:
responsive to user input received from the user via the user interface while displaying an instance of the task template, completing the task.

11. The method of claim 1 further comprising:
responsive to a selection of an entity group by the user from the user interface, presenting only the first option.

12. The method of claim 1 wherein the first and second options are presented to the user concurrently via the user interface.

13. A computer implemented method for visually switching between two procedures for providing access to a task template using a user interface, the method comprising:
displaying, in the user interface, a context-free task list, wherein the tasks of the context-free task list are represented in the user interface by user interface elements for invoking the respective tasks, and wherein a first instance of the task template can be invoked by selecting a user interface element for invoking a context-free task from the context-free task list;
displaying, in the user interface, a topology view, wherein the topology view comprises a plurality of related entities; and
responsive to receiving a selection from a user of an entity from the topology view, displaying a contextual task list, wherein the tasks of the contextual task list are represented in the user interface by user interface elements for invoking the respective tasks, wherein the contextual task list is associated with the selected entity, and wherein a second instance of the task template can be invoked by selecting a user interface element for invoking a contextual task from the contextual task list.

14. The method of claim 13 wherein the context-free task from the context-free task list and the contextual task from the contextual task list are both associated with the task template.

15. The method of claim 13 wherein the context-free task list is a recommended task list.

16. The method of claim 13 wherein the task template comprises a location variable, wherein the location variable contains a location of a user interface of an application.

17. The method of claim 16 wherein invoking the task template comprises displaying the user interface of the application identified by the location variable of the task template.

18. The method of claim 16 wherein the user interface elements representing the context-free task list and the user interface elements representing the contextual task list are displayed simultaneously.

19. A computer implemented method supporting two techniques for task navigation by way of a user interface, the method comprising:
a first technique comprising:
displaying a topology view of a plurality of entities;
receiving, via the user interface, an entity selection from the topology view of the plurality of entities;
displaying a list of contextual tasks associated with the selected entity, wherein the tasks of the list of contextual tasks are represented in the user interface by user interface elements for initiating the respective tasks;
receiving, via the user interface, a selection from the user of a user interface element for initiating a task from the list of contextual tasks; and
displaying a task template associated with the selected task; and
a second technique comprising:
displaying a list of context-free tasks, wherein the tasks of the list of context-free tasks are represented in the user interface by user interface elements for initiating the respective tasks;
receiving, via the user interface, a selection from the user of a user interface element for initiating a task from the list of context-free tasks; and
displaying the same task template associated with the selected task from the list of context-free tasks.

20. The method of claim 19 wherein the selected task from the list of contextual tasks is identical to the selected task from the list of context-free tasks.
